(19) United States
(12) Patent Application Publication
(10) Pub. No.: US 2004/0020733 A1
(43) Pub. Date: Feb. 5, 2004

(54) Non-arcing isolation joint for a DC collector rail

(76) Inventor: Jay M. Shook, West Mifflin, PA (US)

Correspondence Address: Russell D. Orkin, Webb Ziesenheim Logsdon Orkin & Hanson, 700 Koppers Building, 436 Seventh Avenue, Pittsburgh, PA, 15219, US

(21) Appl. No.: 10/211,772

(22) Filed: Aug. 2, 2002

(51) Int. Cl. B60L 1/00

(52) U.S. Cl. 191/2

(57) ABSTRACT

A non-arcing isolation joint for use on a collector rail on which collector shoes move includes a plurality of conductive segments between ends of a first pair of rail sections and between ends of a second pair of rail sections of the collector rail. Insulation is provided between the conductive segments and between the conductive segments and ends of adjacent rail sections. A rectifier is associated with each of the conductive segments to limit DC current flow to one direction. In this manner, as a collector shoe moves over the isolation joint current is prevented from moving between rail sections through the shoe.

### BACKGROUND OF THE INVENTION

1. Field of the Invention

This invention relates to a non-arcing isolation joint between collector rail sections and, more particularly, to a non-arcing isolation joint between collector rail sections of a collector rail for electrically powered vehicles.

2. Discussion of the Technology

Electrically powered vehicles receive energy for propulsion motors through collector shoe sets mounted at both ends of the vehicle. The collector shoe sets pick up power from a collector rail that is mounted along a vehicle guideway and is parallel with the direction of travel. The collector rail, also referred to as power rail and contact rail, includes a plurality of collector rail segments, each segment having a pair of metal sections electrically isolated from one another by a layer of insulators. The collector rail segments have isolated gaps or isolation joints at various points along the guideway. These isolation joints serve to segment the collector rails and provide electrical isolation for the various collector rail segments. The electrical segmentation facilitates operation and maintenance of the guideway system. For example, segmentation allows adjoining power substations to be electrically isolated from each other. Insulation gaps also make possible electrical isolation of guideway switch areas as well as maintenance areas. Distances of 2,000 to 3,000 feet (610 to 915 meters) may exist between isolation joints on expansive transit systems that are several miles long.

The electrical discontinuity between the collector rail sections created by the isolation gaps may effect overall vehicle performance. In these instances, the gaps between the rail sections may be electrically removed for selected periods of time by closing a gap breaker or gap contactor to electrically bypass the isolation gap. For example, bypassing the gaps may reduce voltage drop between rail sections of the collector rail and/or avoid arcing.

Arcing is generally of more concern on direct current (“DC”) systems. DC arcing tends to sustain because there is no current zero occurring every 0.0167 seconds as there is with 60 Hertz (“Hz”) power. Further, a DC system has a very low arc voltage (about 20 volts) needed to sustain an arc. The DC system will generally have high available short circuit currents and lower impedance. Therefore, it is very desirable to prevent DC arcing that may cause damage to the electrical components reducing availability of the electrical system.

The vehicles moving on the guideway have two (2) sets of collector shoes in contact with the collector rails to ensure that at least one set of shoes is in contact with the collector rail at all times. The collector shoe sets connect at a common connection on the vehicle, and the power from the shoe sets is distributed throughout the vehicle from this common connection Having a common connection also means that the two (2) sets of collector shoes act like a jumper (also referred to as bridging) at insulating gaps between conductor rail sections as the vehicle passes over the gaps. Bridging must be accommodated in the protection and safety design of the system at considerable expense. For example, the bridging may occur across an isolation gap and re-energize a dead rail section. The section may be de-energized due to electrical fault, zone emergency trip, or for maintenance purposes.

As can be appreciated, it would be advantageous to provide an isolation joint between DC collector rail sections that does not have the limitations of the presently available gap contact circuits.

### SUMMARY OF THE INVENTION

The invention relates to a non-arcing isolation joint for a direct current (“DC”) collector rail that may be used at various positions in the collector rail system, e.g., the non-arcing isolation joint may be used to electrically separate rails used for customer service requirements, e.g., for passenger movement (“revenue service”) from rails used for maintenance service areas. The isolation joint of the invention can also be used to isolate inner loop revenue service from outer loop revenue service on rail systems that have dual concentric loops with platform stations between them.

In one non-limiting embodiment of the invention, the non-arcing isolation joint includes a pair of electrically conductive segments and an electrically insulating segment between the electrically conductive segments. Each conductive segment is coupled to an electric device, e.g., a rectifier or diode, that restricts the flow of current to or from the conductive segments, with the electric devices arranged to conduct current in the same direction to or from their respective conductive segments.

In another non-limiting embodiment of the invention, the non-arcing isolation joint of the invention is used on an electric collector rail. The collector rail is of the type having a first pair of aligned metal rail sections. A first pair of electrically conductive segments is provided between opposed ends of the first pair of metal rail sections. An electrical insulating segment is provided between the first pair of conductive segments and between each conductive segment and the end of one of the metal rail sections adjacent thereto. A first electric directional device, e.g., a device to prevent feedback, is connected to a first metal rail section of the first pair of metal rail sections and to an adjacent one of the conductive segments of the first pair of conductive segments to restrict a flow of current from the first metal rail section to the one conductive segment, and a second electric device is connected to a second metal rail section of the first pair of metal rail sections and to the other one of the conductive segments of the first pair of conductive segments to limit flow of direct current from the second metal rail section to the other one of the conductive segments.

In a non-limiting embodiment of the invention which includes features of the above embodiment, a second pair of electrically conductive segments is provided between ends of a second pair of aligned metal rail sections. An electrically insulating segment is provided between the second pair of conductive segments and between each one of the second conductive segments and the end of one of the metal rail sections of the second pair of the metal rail sections adjacent thereto. A third electric device, e.g., a device to prevent feedback, is connected to a first metal rail section of the second pair of metal rail sections and to an adjacent one of the conductive segments of the second pair of conductive segments to restrict a flow of current from one of the conductive segments of the second pair of conductive segments to the first metal rail section of the second pair of metal rail sections, and a fourth electric device connected to a second metal rail section of the second pair of metal rail sections and to the other one of the conductive segments of the second pair of conductive segments to restrict a flow of current from the other one of the conductive segments of the second metal rail section of the second pair of metal rail sections.

In still another non-limiting embodiment, the invention covers a method of preventing arcing as a collector shoe moves along a collector rail moving from a first metal rail section to a second metal rail section while preventing direct current from flowing between the first rail section and the second rail section. In the method, a pair of spaced conductive segments is provided between ends of the first and second metal rail sections, and a first set of insulating segments is provided, with an insulating segment of the first set of insulating segments positioned between each metal rail section and its adjacent conductive segment and between the conductive segments. The collector shoe is moved along the first rail section toward the second rail section to move the leading edge of the shoe from the first rail section over a first one of the insulating segments onto a first one of the conductive segments with the trailing end of the shoe remaining on the first rail section while conducting current to the shoe from the first rail sections at least one directly and via the first conductive segment. The leading end of the shoe is moved from the first conductive segment over a second one of the insulating segments onto a second one of the conductive segments and the trailing end of the shoe onto the first conductive segment while conducting current to the shoe from at least one of the first rail via the first conductive segment and the second rail section via the second conductive segment while preventing current from flowing between the first and second rails. The shoe moves its leading edge onto the second rail and the trailing edge of the shoe onto the second segment while conducting current to the shoe from the second rail at least one of directly and via the second conductive segment.

The above method may be practiced with the addition of a second collector shoe moving along a second collector rail from a third metal rail section to a fourth metal rail section while preventing current from flowing between the third rail section and the fourth rail section. A second pair of spaced conductive segments is provided between ends of the third and fourth metal rail sections and a second set of insulating segments is provided, with an insulating segment of the second set of insulating segments positioned between the third rail section and its adjacent conductive segment, between the second pair of conductive segments and between the fourth metal rail section and its adjacent conductive segment. The second collector shoe moves along the third rail section toward the fourth rail section. The leading edge of the second shoe moves from the third rail section over a first insulating segment of the second set of insulating segments onto one of the second pair of conductive segments with the trailing end of the second shoe on the third rail section while conducting current from the second shoe to the third rail section at least one of directly and via the one of the second pair of conductive segments. The second shoe continues to move and the leading end of the second shoe moves from one of the second pair of conductive segments onto the other one of the second pair of conductive segments and the trailing end of the shoe onto the one of the second pair of conductive segments while conducting current from the second shoe to at least one of the third rail section via the one of the second pair of conductive segments and the fourth rail section via the other one of the second pair of conductive segments while preventing current from flowing between the third and fourth rail sections. The leading edge of the second shoe moves onto the fourth rail section and the trailing edge of the second shoe onto the other one of the second pair of conductive segments while conducting current from the second shoe to the fourth rail section at least one of directly and via the other of the second pair of conductive segments.

### DESCRIPTION OF THE DRAWINGS

FIG. 1 is a plan view of a rail system incorporating features of the invention;

FIG. 2 is a view taken along lines 2-2 of FIG. 1 having portions removed for purposes of clarity;

FIG. 3 is a plan view of a non-limiting embodiment of the non-arcing isolation joint of the invention; and

FIG. 4 is a plan view of another non-limiting embodiment of the non-arcing isolation joint of the invention.

### BRIEF DESCRIPTION OF THE PREFERRED EMBODIMENT

As used herein, spatial or directional terms, such as “inner”, “outer”, “left”, “right”, “up”, “down”, “horizontal”, “vertical”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, and so forth, used in the specification and claims are to be understood as being modified in all instances by the term “about”. Accordingly, unless indicated to the contrary, the numerical values set forth in the following specification and claims can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 5.5 to 10. Also, as used herein, the terms “deposited over”, “applied over”, or “provided over” mean deposited, applied, or provided on but not necessarily in surface contact with. For example, a material “deposited over” a substrate does not preclude the presence of one or more other materials of the same or different composition located between the deposited material and the substrate.

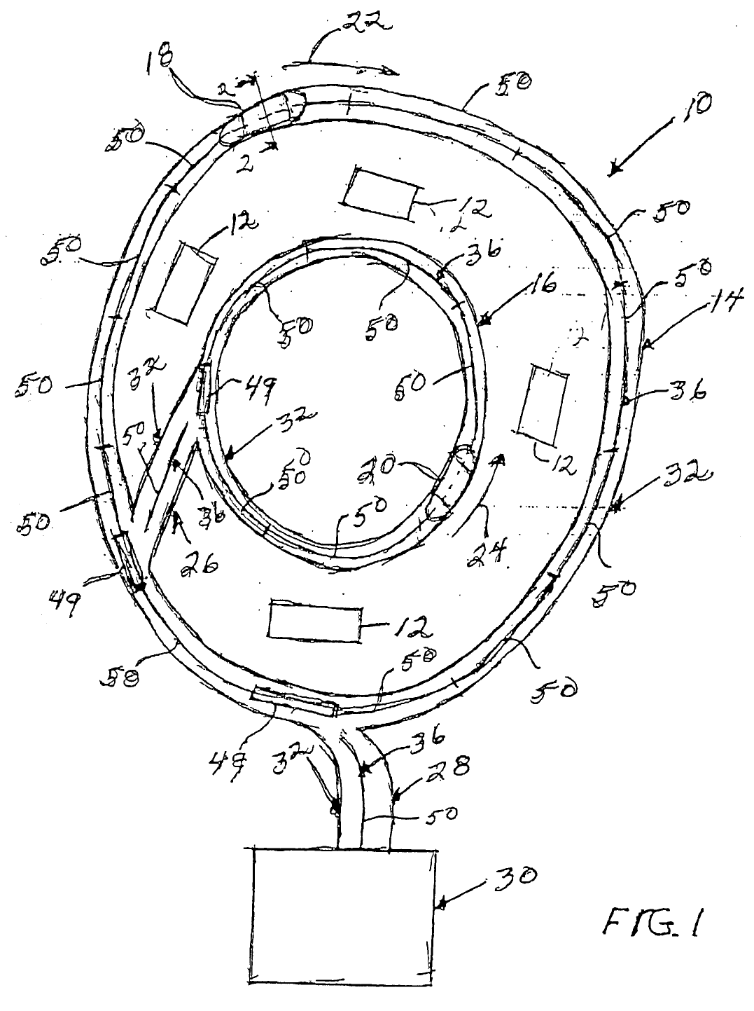

With reference to FIG. 1 there is shown a rail system 10 for moving people between stations 12. The rail system 10 includes outer circular track 14 and inner circular track 16 on which electric powered vehicles 18 and 20, respectively, move in the direction of the arrows 22 and 24, respectively. Side track 26 interconnects the inner track and the outer track or revenue tracks, and side track 28 interconnects the maintenance area 30 to the outer revenue track. As can be appreciated by those skilled in the art of rail systems, the invention is not limited to a circular rail system of the type shown in FIG. 1, and may be used with non-circular rail system, e.g. a rail system having tracks in a linear direction.

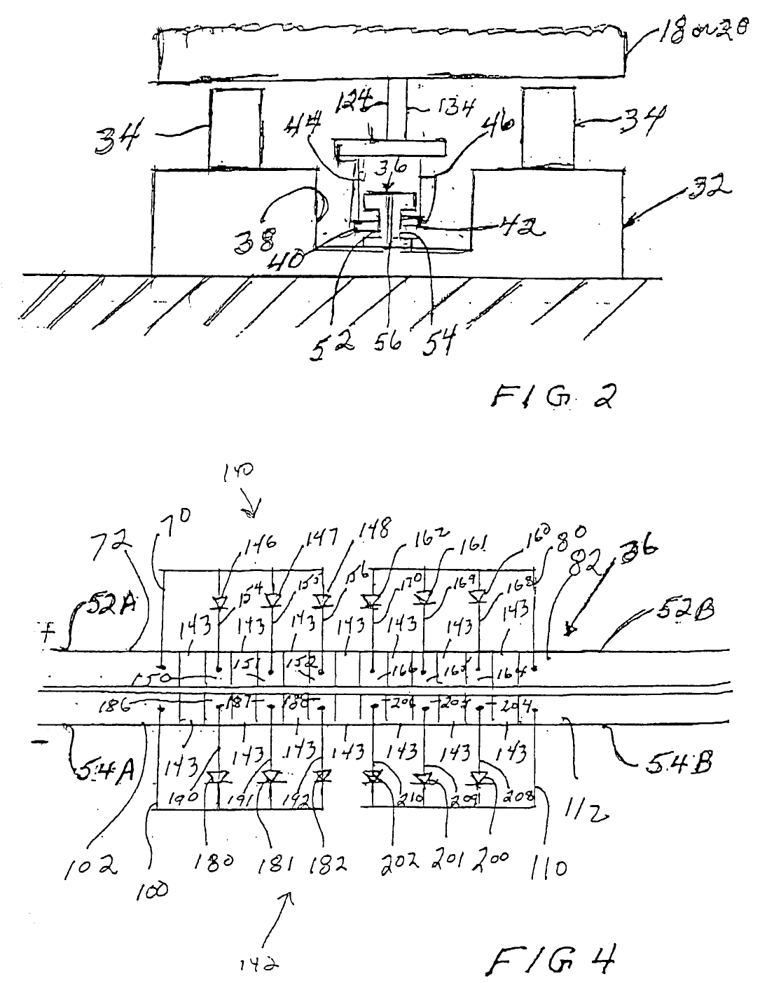

With reference to FIGS. 1 and 2 as needed, the outer, inner, and side tracks 14, 16, 26, and 28 each include a guideway 32 on which wheels 34 (shown only in FIG. 2) of the vehicles 18 or 20 ride. A collector or conductor rail 36 is mounted in a channel 38 formed in the guideway 32. Collector shoe sets (only shoes 40 and 42 of one set shown in FIG. 2) ride one on each side of the collector rail 36 for current to flow from the collector rail 36 along the cables 44 and 46, respectively, to a common cable discussed below, then to a common connector point and from the common connector point to a main switch for power distribution to equipment on the vehicle, e.g., electric motor (not shown). Since the mechanical and electrical arrangement for moving current from the common cable to the main switch and to the equipment is well known in the art of transit systems, no further discussion is deemed necessary.

Referring now to FIG. 1, the side track 26 interconnects the outer track 14 and the inner track 16, and the side track 28 interconnects the outer track 14 and the maintenance area 30 in the usual manner. For example, the outer and inner tracks, and outer track 14 and the maintenance area 30 are interconnected by a guideway switch 49 which redirects the vehicle from the outer track 14 to the inner track 16 or from the outer track 14 to the maintenance area 30.

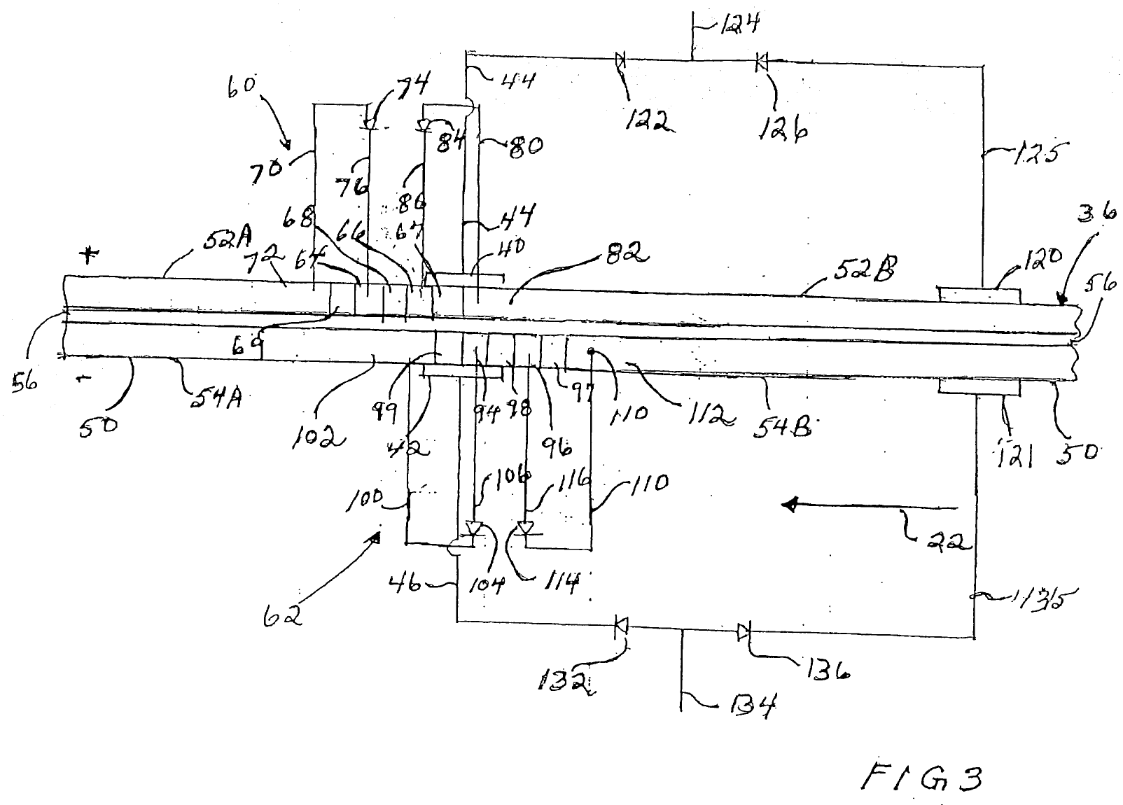

The collector rail 36 is made of rail segments 50, e.g., but not limiting to the invention, each about 2,000 to 3,000 feet (610 to 915 meters) in length and each connected to a power supply station (not shown). With reference to FIGS. 2 and 3, each of the segments of the collector rail 36 has a metal rail section 52 connected to the positive pole of the power supply (not shown), and a metal rail section 54 connected to the negative pole of the power supply. A layer 56 of insulating material, e.g., but not limiting to the invention, porcelain, phenol, fiberglass-reinforced polyester, electrically isolates the metal rail sections 52 and 54 from each other. As can be appreciated, the design of the rails on which the collector shoes set or ride, e.g., as shown in FIG. 2, is not limiting to the invention.

The discussion will now be directed toward the non-arcing isolation joint incorporating features of the invention. With specific reference to FIG. 3, the non-arcing isolation joint 60 is positioned between the positive metal rail section 52 of the conductor rail 36, and the non-arcing isolation joint 62 is positioned between the negative metal rail section 54 of the conductor rail 36. The joint 60 includes a pair of conductive segments 64 and 66 separated from one another and the adjacent end of the metal rail section 52 by insulating segments 67, 68, and 69. A cable 70 interconnects end portion 72 of the left metal rail segment 52, as viewed in FIG. 3 (designated as 52A in FIG. 3 for ease of discussion), with input side, e.g., the anode terminal, of an electric directional device, e.g., diode or rectifier 74; the output side, e.g., cathode terminal, of the rectifier 74 is connected by cable 76 to the conductive segment 64. A cable 80 interconnects end portion 82 of the right metal rail section 52, as viewed in FIG. 3 (designated as 52B in FIG. 3 for ease of discussion), with the input side or anode terminal of an electric directional device, e.g., diode or rectifier 84. The output side or cathode terminal of the rectifier 84 is connected by cable 86 to the conductive segment 66.

As the collector shoe 40 moves in the direction of the arrow 22, the leading end of the collector shoe 40 moves from the end portion 82 of the rail section 52B onto the insulating segment 67 and, thereafter, onto the conductive segment 66. With the leading end of the shoe 40 on the insulating segment 67 and the trailing end on the end portion 82, current is supplied to the shoe 40 by the metal rail section 52B. With the trailing end of the collector shoe 40 on the end portion 82 of the metal rail section 52B and the leading end of the collector shoe 40 on the conductive segment 66, current is supplied to the shoe 40 by the metal rail section 52B and the conductive segment 66 which passes current from the metal rail section 52B through the rectifier 84. When the leading end of the collector shoe 40 moves onto the insulating segment 68, the trailing end of collector shoe 40 contacts insulating segment 67. Hence, the shoe 40 passes current from the conductive segment 66. As the leading end of the shoe 40 moves onto the conductive segment 64 and the trailing end is on the conductive segment 66, the shoe 40 passes current from the conductive segments 64 and 66, depending on the voltages applied to rail segments 52A and 52B. The rectifiers 74 and 84 keep the power on each side of the rail sections 52A and 52B isolated even though the collector shoe 40 bridges the sections 52A and 52B when the shoe 40 is in contact with the conductive segment 64 and/or 66 depending on the voltages applied to rail segments 52A and 52B. Current is supplied to the conductive segment 66 as previously discussed, and current is supplied to the conductive segment 64 from the end portion 72 of the metal rail section 52A through the rectifier 74. As the leading end of the shoe 40 moves onto the insulating segment 69, the trailing end of the shoe 40 is on the conductive segment 64, the shoe 40 is passing current from the conductive segment 64 which is passing current from the end portion 72 of the metal rail section 52A. When the leading end of the shoe 40 is on the end portion 72 of the metal rail section 52A and the trailing end is on the insulating segment 69, current from the metal rail section 52A passes to the conductor shoe 40.

The joint 62 includes a pair of conductive segments 94 and 96 separated from one another and the adjacent end of the metal rail section 54 by insulating segments 97, 98, and 99. A cable 100 interconnects end portion 102 of the left metal rail section 54, as viewed in FIG. 3 (designated as 54A in FIG. 3 for ease of discussion), with output side or cathode terminal of a rectifier 104; the input side or anode terminal of the rectifier 104 is connected by cable 106 to the conductive segment 94. A cable 110 interconnects end portion 112 of the right metal rail section 54, as viewed in FIG. 3 (designated as 54B in FIG. 3 for ease of discussion), with output side or cathode terminal of a rectifier 114; the input side or anode terminal of the rectifier 114 is connected by cable 116 to the conductive segment 96.

As the collector shoe 42 moves in the direction of the arrow 22, the leading end of the collector shoe 42 moves from the end portion 112 of the rail section 54B onto the insulating segment 97 and, thereafter, onto the conductive segment 96. With the leading end of the shoe 42 on the insulating segment 97 and the trailing end on the end portion 112, current moves from the shoe 42 to the metal rail section 54B. With the trailing end of the collector shoe 42 on the end portion 112 of the metal rail section 54B and the leading end of the collector shoe 42 on the conductive segment 96, current is supplied from the shoe 42 to the metal rail section 54B and the conductive segment 96 which passes current through the rectifier 114 to the metal rail section 54B. When the leading end of the collector shoe 42 moves onto the insulating segment 98, the trailing end of collector shoe 42 contacts insulating segment 97. Hence, the shoe 42 passes current to the conductive segment 96 that passes current to the metal rail section 54B through the rectifier 114. As the leading end of the shoe 42 moves onto the conductive segment 94 and the trailing end of the shoe 42 is on the conductive segment 96, the shoe 42 passes current to the conductive segment 94 and/or 96, depending on the voltages applied to rail segments 54A and 54B. Current passes from the conductive segment 96 through the rectifier 114 to the end portion 112 of the metal rail section 54B, and current from the conductive segment 94 passes current to the end portion 102 of the metal rail section 54A through the rectifier 104. As the leading end of the shoe 42 moves onto the insulating segment 99, the trailing end of the shoe 42 is on the conductive segment 94, the shoe 42 passing current to the conductive segment 94 which passes current to the end portion 102 of the metal rail section 54A. When the leading end of the shoe 42 is on the end portion 102 of the metal rail section 54A and the trailing end is on the insulating segment 99, current passes from the conductor shoe 42 to the metal rail section 54A.

As can now be appreciated, the non-arcing isolating joint incorporating features of the invention prevents arcing because, unlike gap conductors, DC current does not flow from one rail section to the other. As the conductor shoe moves from one rail section, e.g., section 52B or 54B over the isolation joint to the other rail section, e.g., section 52A or 54B, respectively, and from one power source to another power source, at no time is the current to the vehicle interrupted. The non-arcing isolation joint electrically isolates each rail section because the rectifiers and insulating segments of the joint are arranged to prevent current from moving from one rail section to the other through the collector shoes. The length of the insulating segments, conductive segments, and the collector shoes is not limiting to the invention and should be sized to prevent current from passing between the conductive segment and the ends of the metal rail portions of the rail sections. The insulating segments may be air or insulating material, such as the type discussed above. In the instance where air is used, the gap should be wide enough to insulate adjacent conductor segments; an air gap of about 1½ inches (3.81 centimeters) is acceptable with air having an insulating factor of 10,000 volts per inch (3937 volts/cm). The conductor shoe should have a length suffice to have at least a potion of the shoe in direct or indirect (through a rectifier) contact with a metal rail section but not in direct contact with each of the metal rail sections, e.g., 52A and 52B. In our non-limiting example, with the conduction segment and insulating segments each having a length of 1½ inches, the length of the conductor shoe should be less than 4.5 inches (11.43 cm), preferably less than 4 inches (10.16 cm) and not less than 3 inches (7.62 cm), to make certain that the shoe, as it moves from one rail segment to the next, receives current as it moves over the joint.

With continued reference to FIG. 3 and as discussed above, the vehicle has two collector shoe sets, e.g., one set includes shoes 40 and 42, and the other set includes shoes 120 and 121 to make certain that there is at least one shoe from each set in contact with the collector rail at all times. One shoe from each set, e.g., shoes 40 and 120, are in contact with the positive side of the collector rail 36, and one shoe from each set, e.g., shoes 42 and 121, are in contact with the negative side of the collector rail 36. The collector shoe 40 is connected by the cable 44 to the input end or anode terminal of rectifier 122; the output end or cathode terminal of the rectifier 122 is connected by cable 124 to the positive pole of the common connector (not shown). The conductor shoe 120 is connected by cable 125 to input end or anode terminal of the rectifier 126; the output end or cathode terminal of the rectifier 126 is connected by the cable 124 to the positive pole of the common connector. The collector shoes 42 and 121 are each associated with the negative side of the collector rail 36. The collector shoe 42 is connected by cable 46 to the output end or cathode terminal of rectifier 132, the input end or anode terminal of the rectifier 132 connected by cable 134 to the negative pole of the common connector. The collector shoe 121 is connected by cable 135 to the output end or cathode terminal of rectifier 136; the input end or anode terminal of the rectifier 136 is connected by the cable 134 to the negative pole of the common connector. With this arrangement, there is no current bridging across the isolation joints, e.g., isolation joints 60 and 62, thereby preventing current from moving from one rail section to the other rail section through the shoes.

As can now be appreciated, the invention is not limited to the use of rectifiers to provide one direction current flow and any type of electric directional device or arrangement of electrical components to limit DC current flow to one direction, e.g., prevent feedback, may be used in the practice of the invention, e.g., diodes. Further, the rating of the rectifiers is not limiting to the invention and should be rated to be equal to or exceed the expected maximum power load or voltage for the vehicle, and the reverse voltage rating for the rectifiers should be greater than the system voltage. Still further, the non-arcing isolation joints of the invention do not have to be offset as shown in FIG. 3, but can be aligned with one another as shown in FIG. 4. The invention is not limited to the mechanical arrangement to secure the non-arcing isolation joints of the invention between the ends of the rail sections. The insulating and conductive segments and the rectifiers may be packaged as a unit and set between the ends of the of rail sections

The invention is not limited to the number of conductive segments in a non-arcing isolation joint, e.g., a joint may have two or more, e.g., but not limiting to the invention up to six conductive segments as shown in FIG. 4; however, at least one insulating segment should be associated with each end of a rail segment to prevent current from moving from a conductive segment directly through the shoe to an adjacent end portion of the collector rail section.

With reference to FIG. 4, non-arcing isolation joint 140 between rail sections 52A and 52B and non-arcing isolation joint 142 between rail sections 54A and 54B each include six (6) rectifiers separated from one another and end portions of rail sections 52A and 52B and 54A and 54B by insulating segments 143. Input end or anode terminal of each of the rectifiers 146, 147, and 148 is connected to the end portion 72 of the rail section 52A by the cable 70, and the output end or cathode terminal of the rectifiers 146, 147, and 148 is connected to conductive segments 150, 151, and 152 by cables 154, 155, and 156, respectively. The input end or anode terminal of each of the rectifiers 160, 161, and 162 is connected to the end portion 82 of the rail section 52B by the cable 80 and the output end or cathode terminal of the rectifiers 160, 161, and 162 is connected to conductive segments 164, 165, and 166 by cables 168, 169, and 170, respectively. The output end or cathode terminal of each of the rectifiers 180, 181, and 182 is connected to the end portion 102 of the rail segment 54A by the cable 100 and the input end or anode terminal of the rectifiers 180, 181, and 182 is connected to conductive segments 186, 187, and 188 by cables 190, 191, and 192. The output end or cathode terminal of each of the rectifiers 200, 201, and 202 is connected to the end portion 112 of the rail section 54B by the cable 110 and the input end or anode terminal of the rectifiers 200, 201, and 202 is connected to conductive segments 204, 205, and 206 by cables 208, 209, and 210. It is to be appreciated that one rectifier can be replaced by two rectifiers in series having the rating of the single replaced rectifier.

The non-arcing isolation joint of the invention may be used with or replace gap connectors presently used. In the system shown in FIG. 1, it is recommended, but not limiting to the invention, to use the joints of the instant invention in the collector rails of the side tracks 26 and 28 to isolate the outside rail from the inside rail when the side track 26 is used and to isolate the outer rail from the maintenance rail when the side track 28 is used.

The particular embodiments described in detail herein are illustrative only and are not limiting to the scope of the invention, e.g., the vehicle may be any of the types used to move cargo and/or people.

It will be appreciated by those skilled in the art that changes could be made to the embodiments described above without departing from the broad inventive concept thereof. Based on the description of the embodiments of the invention, it can be appreciated that this invention is not limited to the particular embodiments disclosed, but it is intended to cover modifications that are within the spirit and scope of the invention, as defined by the appended claims

What is claimed is:

1. A non-arcing isolation joint, comprising:
a pair of electrically conductive segments;
an electrically insulating segment between the conductive segments; and
a pair of electric devices each configured to conduct current in only one direction, with one of the electric devices coupled to one of the conductive segments, with the other electric device coupled to the other conductive segment and with each electric device arranged to conduct current in the same direction to or from its respective conductive segment.

2. The non-arcing isolation joint according to claim 1, wherein the insulating segment is air.

3. The non-arcing isolation joint according to claim 1, wherein the electric device is at least one of a rectifier and a diode.

4. The non-arcing isolation joint according to claim 3, wherein the insulating segment is layer of electrically insulating material.

5. A non-arcing isolation joint for use on an electric collector rail having a first pair of aligned metal rail sections spaced from one another, and a second pair of aligned metal rail sections spaced from each other and the first pair of metal rail sections, comprising:
a first pair of electrically conductive segments between ends of the first pair metal rail sections;
insulating segments positioned between the first pair of electrically conductive segments and between each of the first pair of metal rail sections and one of the first pair of electrically conductive segments;
a first electric device connected between one of the first pair of metal rail sections and one of the first pair of conductive segments to conduct current only from the one of the first pair of metal rail sections to the one of the first pair of conductive segments; and
a second electric device connected between the other one of the first pair of metal rail sections and the other one of the first pair of conductive segments to conduct current only from the other of the first pair of metal rail sections to the other of the first pair of conductive segments.

6. The non-arcing isolation joint according to claim 5, further comprising:
a second pair of electrically conductive segments between the second pair of metal rail sections;
insulating segments positioned between the second pair of electrically conductive segments and between each of the second pair of metal rail sections and one of the second pair of electrically conducting segments;
a third electric device connected between one of the second pair of metal rail sections and one of the second pair of conducting segments to conduct current only to one of the second pair of conducting segments from one of the second pair of metal rail sections; and
a fourth electric device connected between the other of the second pair of metal rail sections and the other of the second pair of conducting segments to conduct current only to the other of the second pair of conductive segments from the other of the second pair of metal rail sections.

7. The non-arcing insulation joint according to claim 5, further including:
a first collector shoe associated with the first pair of metal rail sections; and
a third electric device in contact with the first collector shoe for conducting current only from either the first collector shoe and the first pair of metal rail sections or toward the collector shoe and the first pair of metal rail sections.

8. The non-arcing isolation joint according to claim 7, further including:
a second collector shoe spaced from the first collector shoe and associated with the first pair of metal rail sections;
a fourth electric device in contact with the second collector shoe for conducting current only from either the second collector shoe and the first pair of metal rail sections or toward the second collector shoe and the first pair of metal rail sections, wherein the third and fourth electric devices conduct current in the same direction relative to the first pair of metal rail sections.

9. The non-arcing isolation joint according to claim 6, further including:
a first pair of collector shoes spaced from one another;
a second pair of collector shoes spaced from one another, wherein one shoe from each pair is associated with the first pair of rail sections and the other shoe from each pair is associated with the second pair of metal rail sections;
an electric device associated with each collector shoe associated with the first rail section to conduct current from the first pair of rail sections; and
an electric device associated with each collector shoe associated with the second rail section to conduct current toward the second pair of rail sections.

10. The non-arcing isolation joint according to claim 5, wherein each electric device is at least one of a diode and a rectifier.

11. The non-arcing isolation joint according to claim 5, further including:
a first plurality of conductive segments associated with one of the conductive segments of the first pair of conductive segments, with each of the first plurality of conductive segments coupled to a terminal of an associated electric device for conducting current only in the same direction as the associated one of the conductive segments of the first pair of conductive segments; and
a second plurality of conductive segments associated with the other one of the conductive segments of the first pair of conductive segments with each of the second plurality of conductive segments coupled to a terminal of an associated electric device for conducting current only in the same direction as the associated other one of the conductive segments of the first pair of conductive segments.

12. The non-arcing isolation joint according to claim 6, further including:
a first plurality of conductive segments associated with one of the conductive segments of the first pair of conductive segments, with each of the first plurality of conductive segments coupled to a terminal of an associated electric device for conducting current only in the same direction as the associated one of the conductive segments of the first pair of conductive segments; and
a second plurality of conductive segments associated with the other one of the conductive segments of the first pair of conductive segments with each of the second plurality of conductive segments coupled to a terminal of an associated electric device for conducting current only in the same direction as the associated other one of the conductive segments of the first pair of conductive segments;
a third plurality of conductive segments associated with one of the conductive segments of the second pair of conductive segments, with each of the third plurality of conductive segments coupled to a terminal of an associated electric device for conducting current only in the same direction as the associated one of the conductive segments of the second pair of conductive segments; and
a fourth plurality of conductive segments associated with the other one of the conductive segments of the second pair of conductive segments, with each of the fourth plurality of conductive segments coupled to a terminal of an electric device for conducting current in the same direction as the associated other one of the conductive segments of the second pair of conductive segments.

13. A method of avoiding arcing as a collector shoe moves from a first rail to a second rail while preventing electrical current from flowing between the first rail and the second rail, comprising the steps of:
providing a pair of spaced conductive segments between ends of the first and second rails;
providing a first set of insulating segments, with an insulating segment of the first set of insulating segments positioned between each rail and its adjacent conductive segment and between the conductive segments;
moving a collector shoe along the first rail section toward the second rail section;
moving the leading edge of the shoe from the first rail section over a first insulating segment of the first set of insulating segments onto a first one of the conductive segments with the trailing end of the shoe on the first rail while conducting current to the shoe from the first rail at least one of directly and via the first conductive segment;
moving the leading end of the shoe from the first conductive segment over a second insulating segment of the first set of insulating segments onto a second one of the conductive segments and the trailing end of the shoe onto the first one of the conductive segments while conducting current to the shoe from at least one of the first rail via the first one of the conductive segments and the second rail via the second one of the conductive segments while preventing current from flowing between the first and second rails; and
moving the leading edge of the shoe onto the second rail and the trailing edge of the shoe onto the second one of the conductive segments while conducting current to the shoe from the second rail at least one of directly and via the second one of the conductive segments.

14. The method according to claim 13, further including a second collector shoe moving from a third rail to a fourth rail while preventing electrical current from flowing between the third rail and the fourth rail, comprising the steps of:
providing a second pair of spaced conductive segments between ends of the third and fourth rails;
providing a second set of insulating segments, with an insulating segment of the second set of insulating segments positioned between the third rail and its adjacent conductive segment, between the second pair of conductive segments and between the fourth rail and its adjacent conductive segment;
moving the second collector shoe along the third rail section toward the fourth rail section;
moving the leading edge of the second shoe from the third rail section over a first insulating segment of the second set of insulating segments onto a first one of the second pair of conductive segments with the trailing end of the second shoe on the third rail section while conducting current from the second shoe to the third rail at least one of directly and via the first one of the second pair of conductive segments;
moving the leading end of the second shoe from the first one of the second pair of conductive segments onto the second one of the second pair of conductive segments and the trailing end of the shoe onto the first one of the second pair of conductive segments while conducting current from the second shoe to the third rail via at least one of the first one of the second pair of conductive segments of the second set of conductive segments and the fourth rail via the second one of the second pair of conductive segments of the second set of conductive segments while preventing current from flowing between the third and fourth rails; and
moving the leading edge of the second shoe onto the fourth rail section and the trailing edge of the second shoe onto the second one of the second pair of conductive segments while conducting current from the second shoe to the fourth rail section at least one of directly and via the second of the second pair of conductive segments.
